(19) United States
(12) Patent Application Publication
(10) Pub. No.: US 2025/0356834 A1
(43) Pub. Date: Nov. 20, 2025

(54) IMPACT SOUND SYNTHESIS USING PHYSICS-DRIVEN DIFFUSION MODEL

(71) Applicant: INTERNATIONAL BUSINESS MACHINES CORPORATION, ARMONK, NY (US)

(72) Inventors: Chuang Gan, Cambridge, MA (US); Bo Wu, Cambridge, MA (US); Kaizhi Qian, Champaign, IL (US); Yang Zhang, Cambridge, MA (US); Kun Su, Seattle, WA (US)

(21) Appl. No.: 18/666,908

(22) Filed: May 17, 2024

(51) Int. Cl. G10K 15/02; G06V 10/774; G06V 20/40

(52) U.S. Cl. CPC G10K 15/02; G06V 10/774; G06V 20/40

(57) ABSTRACT

According to one embodiment, a method, computer system, and computer program product for predicting and synthesizing audio of an impact depicted in a video is provided. The present invention may include reconstructing physics priors from received audio and video training data; training a generative model for impact sound synthesis using the reconstructed physics priors to guide the generative model in learning a correspondence between video inputs and impact sounds; receiving silent video input to produce a visual latent vector representation, wherein the video input depicts an impact between two or more physical objects; and processing the visual latent vector representation, the reconstructed physics priors, and Gaussian noise through the trained generative model to perform the impact sound synthesis.

The following disclosure is submitted under 35 U.S.C. § 102(b)(1)(A):

DISCLOSURE: “Physics-Driven Diffusion Models for Impact Sound Synthesis from Videos”, Kun Su, Kaizhi Qian, Eli Shlizerman, Antonio Torralba, and Chuang Gan, Jun. 20-22, 2023, 2023 IEEE/CVF Conference on Computer Vision and Pattern Recognition (CVPR) [book], pp. 9749-9759.

### BACKGROUND

The present invention relates, generally, to the field of computing, and more particularly to sound synthesis.

Sound synthesis is a technique for generating sound from the ground up, ab initio, using electronic hardware or software. Impact sound synthesis can comprise simulating sounds triggered by various types of physical object interactions. Modeling sounds emitted from physical object interactions is crucial for immersive perceptual experiences in both real and virtual worlds.

### SUMMARY

Embodiments of a method, a computer system, and a computer program product for predicting and synthesizing audio of an impact depicted in a video are described. According to one embodiment, a method, computer system, and computer program product for predicting and synthesizing audio of an impact depicted in a video may include reconstructing physics priors from received audio and video training data; training a generative model for impact sound synthesis using the reconstructed physics priors to guide the generative model in learning a correspondence between video inputs and impact sounds; receiving silent video input to produce a visual latent vector representation, wherein the video input depicts an impact between two or more physical objects; and processing the visual latent vector representation, the reconstructed physics priors, and Gaussian noise through the trained generative model to perform the impact sound synthesis.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating an impact sound prediction and synthesis process according to at least one embodiment.

FIG. 3 is an illustration of an impact sound prediction and synthesis process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular to synthesizing high-fidelity impact sounds for a silent video clip using a physics-driven generative model. The present embodiment can analyze a video of two or more physical objects colliding and can extrapolate what sound the collision of the objects would make from the visual data alone. The present embodiment performs an impact sound synthesis process using reconstructed physics priors, whereby the physics priors include a combination of physics parameters and residual parameters, and silent video input to generate realistic audio representing the impact of two or more physical objects.

Currently, impact sound synthesis methods comprise using physics-based synthesis models to simulate sounds triggered by various types of object interactions as seen in a silent video. However, such methods require a sophisticated designed environment to perform the physics simulation, as well as to compute a set of physics parameters for sound synthesis. Thus, it is likely impractical to capture the audio of complex object interactions, in which various sound waves interact with each other and with other objects in various ways, because of a time-consuming parameter selection process. Additionally, current methods comprise training deep learning models for impact sound synthesis using impact sound videos. However, the methods apply end-to-end black box model training and lack the essential physics knowledge that is crucial for the modeling of impact sounds, such as the frequency, power, and decay rate parameters present in the audio waveforms. Thus, the current methods are prone to learning audio representations comprising accidental or unwanted sonic material, which leads to the generation of unfaithful sound. Thus, an implementation of impact sound synthesis is needed, in which reconstructed physics priors are used in training a generative model to synthesize high-fidelity impact sound.

Thus, embodiments of the present invention may provide advantages including, but not limited to, increasing the accuracy and fidelity of generated impact sounds for silent videos. The present invention reconstructs physics priors in audio data, thereby integrating physics knowledge into the impact sound synthesis process. Also, the present invention trains a diffusion model using the reconstructed physics priors and visual latent vector representations of videos, thereby enabling the generation of realistic impact audio. Additionally, the generated impact sound representations are fully interpretable and transparent, thereby enabling the performance of flexible sound editing, such as by sound editors. The present invention does not require that all advantages need to be incorporated into every embodiment of the invention.

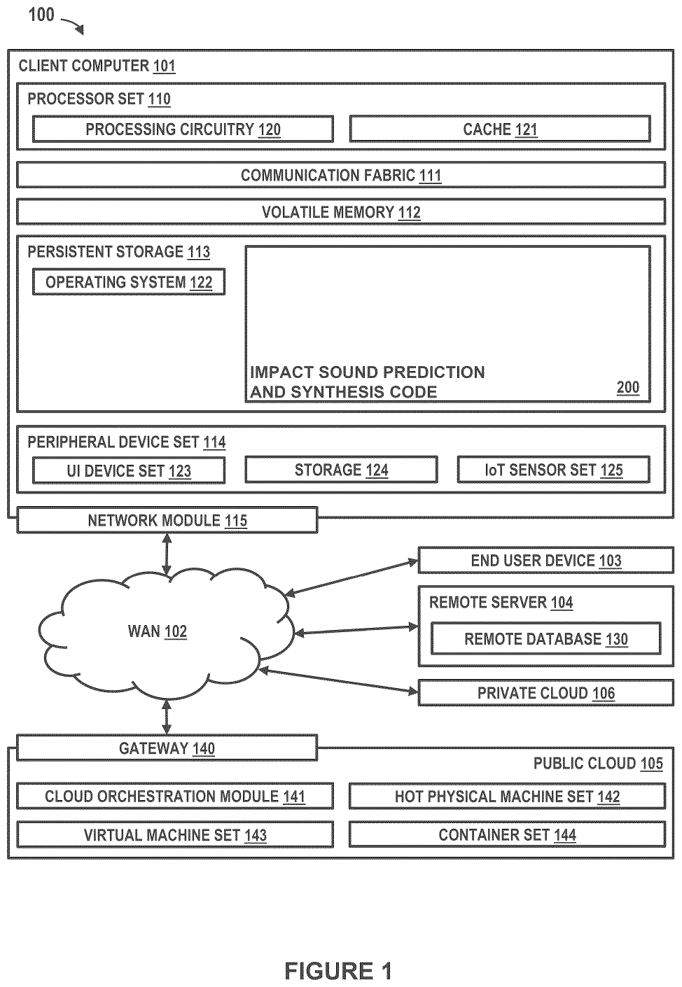

The embodiments mentioned in this paragraph are further illustrated and described below in the discussions of FIGS. 1, 2, and 3. According to at least one embodiment, the impact sound prediction and synthesis program reconstructs physics priors from received audio and video training data. Also, the program trains a generative model for impact sound synthesis using the reconstructed physics priors to guide the generative model in learning a correspondence between video inputs and impact sounds. Furthermore, the program receives silent video input to produce a video latent vector representation, wherein the video input depicts an impact between two or more physical objects. Moreover, the program processes the visual latent vector representation, the reconstructed physics priors, and Gaussian noise through the trained generative model to perform the impact sound synthesis.

According to at least one other embodiment, the generative model comprises a denoising diffusion probabilistic model. According to at least one other embodiment, the program generates a final spectrogram distribution representing an impact sound of the two or more physical objects based on the processing of the visual latent vector representation through the trained generative model. According to at least one other embodiment, the impact sound of the two or more physical objects comprises an impact sound represented in the received audio and video training data or a novel impact sound. According to at least one other embodiment, the training of the generative model for the impact sound synthesis further comprises using visual latent vector representations of the received video training data and Gaussian white noise. According to at least one other embodiment, the reconstructing of the physics priors comprises estimating physics parameters from audio waveforms in the received audio training data and predicting residual parameters represented in the audio. According to at least one other embodiment, the performing of the impact sound synthesis comprises a diffusion forward process and a reverse diffusion process.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to reconstruct physics priors from received audio and video training data, train a generative model for impact sound synthesis using the reconstructed physics priors to guide the generative model in learning a correspondence between video inputs and impact sounds, receive silent video input to produce a visual latent vector representation, wherein the video input depicts an impact between two or more physical objects, and process the visual latent vector representation, the reconstructed physics priors, and Gaussian noise through the trained generative model to perform the impact sound synthesis.

Referring to FIG. 1, an exemplary networked computer environment 100 is depicted, according to at least one embodiment. Computing environment 100 contains an example of an environment for the execution of at least some of the computer code involved in performing the inventive methods, such as impact sound prediction and synthesis code 200, also referred to as “impact sound prediction and synthesis program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 can store uploaded training data, such audio samples and video input received through peripheral device set 114, UI device set 123, etc. The database 130 can store outputted data from the trained generative model, such as generated sound spectrograms, as well as store the trained generative model. Also, the database 130 can store physics priors, as well as physics latent representations and visual latent representations. Moreover, the database 130 can comprise uploaded silent video input.

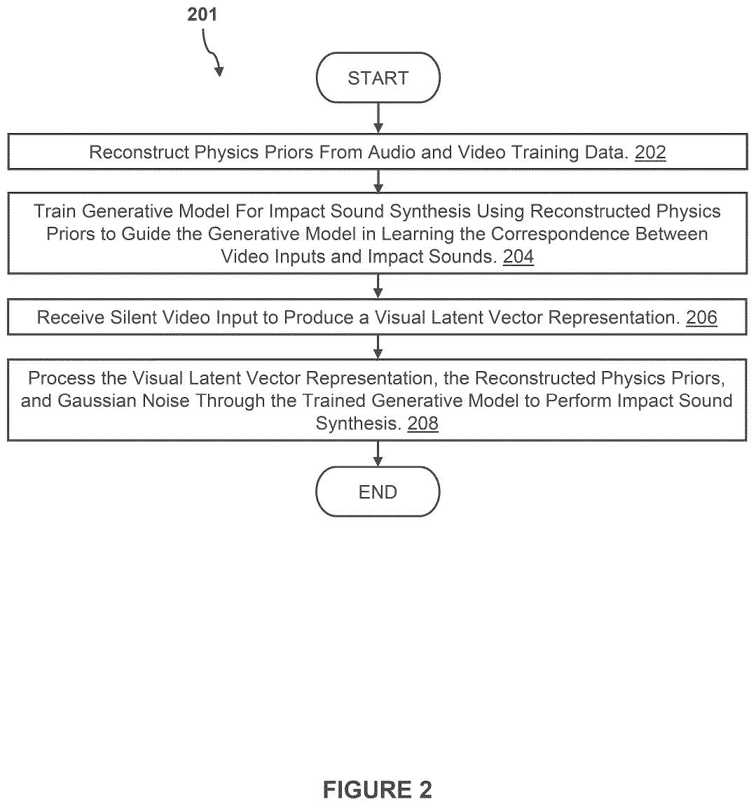

According to the present embodiment, the impact sound prediction and synthesis program 200 may be a program capable of reconstructing physics priors from received audio and video training data. Also, the program 200 may be a program capable of training a generative model for impact sound synthesis using the reconstructed physics priors to guide the generative model in learning the correspondence between video inputs and impact sounds. Additionally, the program 200 may be a program capable of processing a visual latent vector representation, the reconstructed physics priors, and Gaussian noise through the trained generative model to perform impact sound synthesis. The program 200 may be located on client computing device 101 or remote server 104 or on any other device located within network 102. Furthermore, the program 200 may be distributed in its operation over multiple devices, such as client computing device 101 and remote server 104. The impact sound prediction and synthesis method are explained in further detail below with respect to FIG. 2.

Referring now to FIG. 2, an operational flowchart illustrating an impact sound prediction and synthesis process 201 is depicted according to at least one embodiment. At 202, the program 200 reconstructs physics priors from training data. Physics priors include a combination of physics parameters and residual parameters. The program 200 estimates physics parameters from noisy real-world impact sound examples and predicts residual parameters that interpret the sound environment in the sound examples. Training data can comprise video and audio data. The video data, in a video file format, may comprise recorded video of an impact between two or more physical objects, such as an object made of glass coming into contact with an object made of wood, an object made of cloth coming into contact with an object made of metal, an object made of plastic coming into contact with an object made of glass, etc. The audio data may comprise audio waveforms representing the impact between the two or more physical objects. The program 200 may receive training data from the database 130, where the video and audio data may be uploaded and stored.

The program 200 estimates the frequency, f, power, p, and decay rate, λ, together referred to as the physics parameters, from the audio data waveform, s∈ [symbol] , using one or more signal processing techniques, such as short-time-Fourier-transform (“STFT”). The program 200 computes the log-spectrogram magnitude, S∈ [symbol] , of the audio data by performing STFT. The number of frequency bins can be represented by D. The number of frames can be represented by N. The program 200 captures sufficient physics parameters by setting the number of modes to be equal to the number of frequency bins. The program 200 identifies the peak frequency parameter within the range of each frequency bin from the fast Fourier transform (“FFT”) magnitude result of the whole audio segment. The program 200 extracts the magnitude at the first frame in the spectrogram to be the initial power parameter. The program 200 computes the decay time parameter for the mode according to the temporal bin when it reaches silence, around −80 db. During this process, the program 200 obtains D modes physics parameters. The program 200 re-synthesizes an audio waveform, ŝ, using the following Liner Modal Synthesis equation:

$${\sum }_{i = 0}^{n} {p}_{i} {e}^{- {λ}_{i} t} sin ( 2 π {f}_{i} t )$$

Time is represented by t. Additionally, the program 200 predicts the residual parameters from the training data to approximate the sound environment represented in the training data. The residual parameters can comprise weights, @, and decay rate, γ. The sound environment may comprise background noise, acoustic noise, and reverberation. The program 200 approximates the sound environment component with exponentially decaying filtered noise. The program 200 randomly generates a Gaussian white noise [symbol] (0, 1) signal and perform a band-pass filter (“BPF”) to split the white noise into M bands. The program 200 formulates the residual component for each band, m, using the following equation:

$${R}_{m} = {10}^{( - γ t ) / 20} BPF {( ( 0 , 1 ) )}_{m}$$

The accumulated residual components, R, can be a weighted sum of subband residual components, represented by the following equation:

$$R = {\sum }_{m = 1}^{M} {w}_{m} {R}_{m}$$

The weight coefficient of band m residual component can be represented by wₘ. The program 200 uses a transformer-based encoder to encode each frame of the log-spectrogram, S, by inputting the log-spectrogram magnitude, S∈ [symbol] , into the encoder. The program 200 averages the output features of the transformer-based encoder. The program 200 uses two linear projections to estimate γ∈ [symbol] and ω∈ [symbol] . The program 200 obtains the physics priors by combining the estimated physics parameters and the weighted sum of the predicted residual parameters. Also, the program 200 introduces a multi-resolution STFT reconstruction loss, L_{mr-stft}(ŝ+R, s), to the transformer encoder, to minimize the error between ŝ+R and s.

The program 200 inputs the obtained physics priors into a neural network, such as a multi-layered perceptron (“MLP”), to output latent vector representations, μ, of the physics priors. Also, the program 200 inputs the video data within the training data into a visual encoder to obtain visual latent vector representations of the video data. The visual encoder may comprise a temporal shift module (“TSM”). The visual encoder may process the video data through the TSM to extract the visual features. Using an average pooling consensus function, the visual encoder aggregates the video features to generate a single visual latent vector representation, v.

At 204, the program 200 trains a generative model for impact sound synthesis using the reconstructed physics priors. The program 200 can train the generative model to output a final spectrogram distribution representing a generated impact sound. The generative model comprises one or more models for image generation, i.e., generating of spectrograms, such as a denoising diffusion probabilistic model (“DDPM”), herein referred to as the diffusion model. The diffusion model comprises a U-Net spectrogram denoiser architecture, including convolutional layers and two networks. The networks can comprise an encoder network and a decoder network, with a bottleneck layer between the two. Also, the diffusion model comprises one or more skip connections between encoder layers and decoder layers. The diffusion model uses skip connections to directly feed the output of an encoder layer as input into a decoder layer.

The program 200 trains the diffusion model using the reconstructed physics priors, visual latent vector representations, and Gaussian white noise, xₜ, to guide the diffusion model in learning the correspondence between video inputs and impact sounds. The program 200 trains the diffusion model to maximize the log-likelihood of a spectrogram, given a spectrogram distribution, q(x₀|μ, v), by learning a model distribution, p_{θ}(x₀|μ, v), obtained from a reverse diffusion process, to approximate q(x₀|μ, v). Also, the program 200 trains the diffusion model to achieve an L1 loss function between the noise, ∈˜ [symbol] (0, I), and the diffusion model output, f_{θ}, as depicted:

$$( \begin{matrix}min \\ θ\end{matrix} ) {‖ ϵ - {f}_{θ} ( h ( {x}_{0} , ϵ ) , t , μ , v ) ‖}_{1}$$

h(x₀, ϵ) can be equal to \sqrt{\hat{β}}x₀+\sqrt{1−\hat{β}ₜ}∈, and \hat{β}ₜ can be equal to

$${\prod }_{\overline{t} = 1}^{t} 1 - {β}_{\overline{t}} .$$

Additionally, the program 200 trains the diffusion model to construct key-value pairs for the visual and physics latent representations in the training data.

At 206, the program 200 receives silent video input to produce a visual latent vector representation. The program 200 can receive the silent video input from the database 130. The silent video input can be input that comprises video of an impact between one or more physical objects but no audio data of the impact, i.e., no audio waveforms. The program 200 feeds the silent video input into the visual encoder to output a visual latent vector representation, v^{input}. The program 200 inputs the visual latent representation into the trained diffusion model.

At 208, the program 200 processes the visual latent vector representation, the reconstructed physics priors, and Gaussian Noise through the trained diffusion model to perform impact sound synthesis. The impact sound synthesis comprises locating the nearest neighbor in the key-value pair and using the corresponding physics latent representations as the matching pair for the visual latent representation. The trained diffusion model locates the nearest neighbor by taking the v^{input} as a query feature, and finding the key in the training data by computing the Euclidean distance between the visual latent representation, v^{input}, and all the training video latent representations,

$${\{ {v}_{j}^{train} \}}_{j = 1}^{J} .$$

Given the key vⱼ^{train}, the trained diffusion model can use the value,

$${μ}_{j}^{train} ,$$

as the test physics latent representation, \hat{μ}^{input}. Also, the impact sound synthesis comprises a diffusion forward process and a reverse diffusion process. The diffusion forward process comprises adding Gaussian noise, [symbol] (0, 1), at time steps, t=0, . . . , T to a spectrogram, x, with variance scale, β. The trained diffusion model can use a scheduler to change the variance scale at each time step to comprise β₁, β₂, . . . , β_{T}. The spectrogram at diffusion time step t can be denoted as xₜ. The explicit diffusion process for the spectrogram at time step, t, can be depicted as:

$$q ( {x}_{t} \vert {x}_{t - 1} , μ , v )$$

The complete diffusion process, taking x₀ to x_{T} conditioned on u and v, can comprise a Markov process. The Markov process can be factorized into a sequence of multiplication,

$${\prod }_{t = 1}^{T} q ( {x}_{t} \vert {x}_{t - 1} ) .$$

Also, the trained diffusion model performs a reverse diffusion process to guide the noise distribution to a spectrogram distribution corresponding to the physics priors from the training process and the visual latent vector representation. The reverse diffusion process can be defined as the conditional distribution, p_{θ}(x_{0:T-1}|x_{T}, μ, v), and can be factorized into multiple transitions as:

$${p}_{θ} ( {x}_{0} , … , {x}_{T - 1} \vert {x}_{T} , μ , v ) = {\prod }_{t = 1}^{T} {p}_{θ} ( {x}_{t - 1} \vert {x}_{t} , μ , v )$$

The trained diffusion model can predict the added noise at each forward iteration to get model output, f_{θ}(xₜ, t, \hat{μ}^{input}, v^{input}). The trained diffusion model can recover a spectrogram from the physics latent vector representations, the visual latent representation, and the Gaussian noise, by applying the reverse transitions, p_{θ}(xₜ₋₁|xₜ, μ, v). Specifically, the trained diffusion model can remove the noise using the following formula:

$${x}_{t - 1} = \frac{1}{\sqrt{1 - {β}_{t}}} ( {x}_{t} - \frac{{β}_{t}}{\sqrt{1 - {\hat{β}}_{t}}} {f}_{θ} ( {x}_{t} , t , {\hat{μ}}^{{}_{input}} , {v}^{input} ) )$$

\hat{B}ₜ can be equal to

$${\prod }_{\overline{t} = 1}^{t} 1 - {β}_{\overline{t}} , {ϵ}_{t} ∼ ( 0 , I ) ,$$

and η can be equal to

$$σ \sqrt{\frac{1 - {\hat{β}}_{t - 1}}{1 - {\hat{β}}_{t}} {β}_{t}} .$$

A temperature scaling factor of the variance can be represented by σ. The trained diffusion model generates the final spectrogram distribution, p_{θ}(x₀|\hat{μ}^{input}, v^{input}) representing the generated impact sound, after iterative sampling over all of the time steps. The trained diffusion model can generate impact sounds learned during the training process because of the use of the physics latent representations from the training data. Additionally, the trained diffusion model can generate novel impact sounds because the trained diffusion model takes additional visual features as input during the impact sound synthesis process.

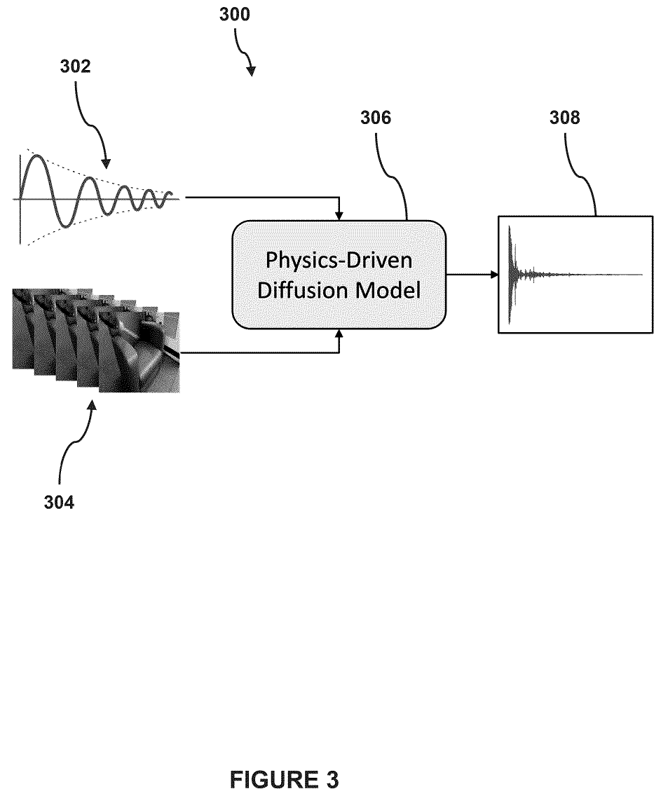

Referring now to FIG. 3, an illustration of an impact sound prediction and synthesis process 300 is depicted according to at least one embodiment. An audio waveform representing reconstructed physics priors 302 is depicted. Also, received silent video input 304 illustrating an impact between two or more physical objects is depicted. Additionally, a spectrogram 308 representing the generated impact sound of the two or more physical objects in the silent video input 304, is depicted. The spectrogram 308 can be generated by processing the reconstructed physics priors 302 and the received silent video input 304 through the diffusion model 306.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for predicting and synthesizing audio of an impact depicted in a video, the method comprising:
reconstructing physics priors from received audio and video training data;
training a generative model for impact sound synthesis using the reconstructed physics priors to guide the generative model in learning a correspondence between video inputs and impact sounds;
receiving silent video input to produce a visual latent vector representation, wherein the video input depicts an impact between two or more physical objects; and
processing the visual latent vector representation, the reconstructed physics priors, and Gaussian noise through the trained generative model to perform the impact sound synthesis.

2. The method of claim 1, wherein the generative model comprises a denoising diffusion probabilistic model.

3. The method of claim 1, further comprising:
generating a final spectrogram distribution representing an impact sound of the two or more physical objects based on the processing of the visual latent vector representation through the trained generative model.

4. The method of claim 3, wherein the impact sound of the two or more physical objects comprises an impact sound represented in the received audio and video training data or a novel impact sound.

5. The method of claim 1, wherein the training of the generative model for the impact sound synthesis further comprises using visual latent vector representations of the received video training data and Gaussian white noise.

6. The method of claim 1, wherein the reconstructing of the physics priors comprises estimating physics parameters from audio waveforms in the received audio training data and predicting residual parameters represented in the audio.

7. The method of claim 1, wherein the performing of the impact sound synthesis comprises a diffusion forward process and a reverse diffusion process.

8. A computer system for predicting and synthesizing audio of an impact depicted in a video, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
reconstructing physics priors from received audio and video training data;
training a generative model for impact sound synthesis using the reconstructed physics priors to guide the generative model in learning a correspondence between video inputs and impact sounds;
receiving silent video input to produce a visual latent vector representation, wherein the video input depicts an impact between two or more physical objects; and
processing the visual latent vector representation, the reconstructed physics priors, and Gaussian noise through the trained generative model to perform the impact sound synthesis.

9. The computer system of claim 8, wherein the generative model comprises a denoising diffusion probabilistic model.

10. The computer system of claim 8, further comprising:
generating a final spectrogram distribution representing an impact sound of the two or more physical objects based on the processing of the visual latent vector representation through the trained generative model.

11. The computer system of claim 10, wherein the impact sound of the two or more physical objects comprises an impact sound represented in the received audio and video training data or a novel impact sound.

12. The computer system of claim 8, wherein the training of the generative model for the impact sound synthesis further comprises using visual latent vector representations of the received video training data and Gaussian white noise.

13. The computer system of claim 8, wherein the reconstructing of the physics priors comprises estimating physics parameters from audio waveforms in the received audio training data and predicting residual parameters represented in the audio.

14. The computer system of claim 8, wherein the performing of the impact sound synthesis comprises a diffusion forward process and a reverse diffusion process.

15. A computer program product for predicting and synthesizing audio of an impact depicted in a video, the computer program product comprising:
one or more computer-readable tangible storage medium and program instructions stored on at least one of the one or more tangible storage medium, the program instructions executable by a processor to cause the processor to perform a method comprising:
reconstructing physics priors from received audio and video training data;
training a generative model for impact sound synthesis using the reconstructed physics priors to guide the generative model in learning a correspondence between video inputs and impact sounds;
receiving silent video input to produce a visual latent vector representation, wherein the video input depicts an impact between two or more physical objects; and
processing the visual latent vector representation, the reconstructed physics priors, and Gaussian noise through the trained generative model to perform the impact sound synthesis.

16. The computer program product of claim 15, wherein the generative model comprises a denoising diffusion probabilistic model.

17. The computer program product of claim 15, further comprising:
generating a final spectrogram distribution representing an impact sound based on the processing of the visual latent vector representation through the trained generative model.

18. The computer program product of claim 17, wherein the impact sound of the two or more physical objects comprises an impact sound represented in the received audio and video training data or a novel impact sound.

19. The computer program product of claim 15, wherein the training of the generative model for the impact sound synthesis further comprises using visual latent vector representations of the received video training data and Gaussian white noise.

20. The computer program product of claim 15, wherein the reconstructing of the physics priors comprises estimating physics parameters from audio waveforms in the received audio training data and predicting residual parameters represented in the audio.
